(19) United States
(12) Patent Application Publication
(10) Pub. No.: US 2026/0352049 A1
(43) Pub. Date: Nov. 5, 2026

(54) ELECTRIC MOTOR, VEHICLE EQUIPPED WITH SAID ELECTRIC MOTOR, AND METHOD FOR OPERATING THE ELECTRIC MOTOR

(71) Applicant: XOOO Mechatronics GmbH, Regau (AT)

(72) Inventor: Klaus GRAUSGRUBER, Breitenschützing (AT)

(73) Assignee: XOOO Mechatronics GmbH, Regau (AT)

(21) Appl. No.: 19/100,172

(22) PCT Filed: Aug. 2, 2023
(86) PCT No.: PCT/AT2023/060259

§ 371 Date: Feb. 25, 2025

(30) Foreign Application Priority Data
Aug. 2, 2022 (AT) A60115/2022

(51) Int. Cl. H02K 1/2798; B60L 7/24; H02K 1/02; H02K 1/22; H02K 3/28; H02K 7/102; H02K 7/106; H02K 11/21; H02K 11/25; H02K 16/02; H02P 3/26

(52) U.S. Cl. CPC H02K 1/2798; B60L 7/24; H02K 1/02; H02K 1/223; H02K 3/28; H02K 7/102; H02K 7/106; H02K 11/21; H02K 11/25; H02K 16/02; H02P 3/26; B60L 2220/18; B60L 2220/44

(57) ABSTRACT

An electric motor includes a rotor and a stator, the rotor being rotatable relative to the stator about a rotational axis. Furthermore, a first row of coils including first coils are arranged on the rotor or on the stator in a first regular pattern distributed about the rotational axis. Furthermore, a second row of coils including second coils are arranged on the rotor or on the stator in a second regular pattern distributed about the rotational axis, wherein the first row of coils and the second row of coils are spatially separated on the same component selected from the rotor or the stator, wherein the second coils of the second row of coils can be energized independently of the first coils of the first row of coils.

The invention relates to an electric motor, a vehicle equipped with said electric motor and a method for operating the electric motor.

DE2511452A1 discloses an electric motor.

The electric motor known from DE2511452A1 is of inadequate quality.

The object of the present invention was to overcome the disadvantages of the prior art and to provide an electric motor with an optimised construction. Furthermore, a vehicle equipped with said electric motor is to be created, as well as an improved method for operating the electric motor.

This object is achieved by a device and a method according to the claims.

According to the invention, an electric motor is provided. The electric motor comprises:
a rotor;
a stator;
a rotational axis, the rotor being rotatable relative to the stator about the rotational axis.

Furthermore, a first row of coils comprising a plurality of first coils is provided, said first coils being arranged on the rotor or the stator in a first regular pattern distributed about the rotational axis. Furthermore, a second row of coils comprising a plurality of second coils is provided, said second coils being arranged on the rotor or the stator in a second regular pattern distributed about the rotational axis separately from the first row of coils, wherein the second coils of the second row of coils can be energised independently of the first coils of the first row of coils.

The electric motor according to the invention has the advantage that the structure according to the invention with two row of coils enables a large number of operating modes and the electric motor can therefore be used in a variety of ways.

The expression “on the same component selected from the rotor or the stator” has the following meaning. If the first row of coils is arranged on the rotor, the second row of coils is also arranged on the rotor. If the first row of coils is arranged on the stator, the second row of coils is also arranged on the stator.

The plurality of first coils of the first row of coils may be indexed and thus identified as individual coils. Such indexing may be structured as follows: first first coil, second first coil, third first coil, fourth first coil, and so on.

The plurality of second coils of the second row of coils may be indexed and thus identified as individual coils. Such indexing may be structured as follows: first second coil, second second coil, third second coil, fourth second coil, and so on.

Furthermore, it may be useful if all of the first coils of the first row of coils are offset at an offset angle about the rotational axis with respect to the nearest second coil of the second row of coils. This measure has the advantage that the electric motor has an optimised operating behaviour.

In other words, the first coils of the first row of coils and the second coils of the second row of coils may have the same regular pattern with respect to the angular distribution in arrangement about the rotational axis. The regular pattern of the second coils of the second row of coils may be shifted by the offset angle to the regular pattern of the first coils of the first row of coils. This means that the first first coil may be offset from the first second coil at an offset angle.

Furthermore, it may be provided that first iron cores are inserted into the first coils, in particular in that the first iron cores each have a first stack of plates with a plurality of first plates arranged one above the other, wherein the first iron cores are configured in a U-shaped manner with a first leg and a second leg and a first base connecting the two legs, and wherein the first leg of the first iron cores is arranged respectively within one of the first coils, and in that second iron cores are inserted into the second coils, in particular in that the second iron cores each have a second stack of plates with a plurality of second plates arranged one above the other, wherein the second iron cores are configured in a U-shaped manner with a first leg and a second leg and a second base connecting the two legs, and wherein the first leg of the second iron cores is arranged respectively within the second coils. This measure has the surprising advantage that the electric motor shows an optimised efficiency. In particular, the construction of the iron cores consisting of plates may simplify manufacturability.

Furthermore, it may be provided that the offset angle is selected such that the second leg of the second iron core is arranged as an extension of the first leg of the first iron core and that the first leg of the second iron core is arranged as an extension of the second leg of the first iron core. These measures can further improve the course of the magnetic field lines, which can further increase the efficiency of the electric motor.

Another advantageous embodiment is that the individual first coils of the first row of coils can be energised completely independently of each other. This measure makes it possible to achieve an exact angular positioning of the rotor relative to the stator. In addition, this measure allows the speed to be easily adjusted.

In an alternative embodiment variant, it may be provided that the individual first coils of the first row of coils are combined in energisation groups, wherein the first coils of an energisation group can be energised together and the different energisation groups can be energised independently of one another. This measure makes it possible to achieve an exact angular positioning of the rotor relative to the stator. In addition, this measure allows the speed to be easily adjusted.

In particular, it may be provided that the first coils of the first row of coils are combined in a first energisation group, a second energisation group and a third energisation group. The individual first coils may thus be associated with the energisation groups as follows: first first coil—first energisation group; second first coil—second energisation group; third first coil—third energisation group; fourth first coil—first energisation group; fifth first coil—second energisation group; sixth first coil—third energisation group; and so on.

In particular, it may be provided that the first row of coils and the second row of coils comprise the same number of coils.

In particular, it may be provided that the number of coils can be divided by three as an integer.

In particular, it may be provided that the first row of coils comprises twelve coils, four of the coils being combined in the first energisation group, four of the coils being combined in the second energisation group and four of the coils being combined in the third energisation group. This type of electric motor design offers a surprising advantage in terms of the ratio of motor power to motor weight.

According to an advancement, it is conceivable that a parking brake is provided, wherein a brake element is displaceably arranged on the stator, in particular displaceable in the axial direction, wherein the brake element is configured for positive engagement with a shaped recess on the rotor. This measure can further improve the universal applicability of the electric motor. Particularly in conjunction with the extended application possibilities of the first and second row of coils, the parking brake offers surprising technical advantages in use. Especially when using the electric motor in a vehicle, an external parking brake can be dispensed with by integrating a parking brake. This means that the overall structure of the vehicle can be kept as simple as possible.

Furthermore, it may be useful if a toothing is configured on the brake element and if a mating toothing is configured on the rotor, wherein the toothing can be brought into positive engagement with the mating toothing. In particular, a parking brake configured in this way can be activated in any position by the toothing, allowing the rotor to be locked in almost any position.

In addition, it may be provided that the first coils of the first row of coils are controlled by a first circuit board and the second coils of the second row of coils are controlled by a second circuit board, wherein the first row of coils and the second row of coils are configured for a redundant operation. This measure can increase the reliability of the electric motor. In particular, this measure allows the electric motor to be used in safety-critical applications. If, for example, the electric motor is used for operation in a vehicle and the electric motor is used to provide the necessary braking energy, it may be necessary or unavoidable for safety reasons that the electric motor has redundancy and thus a redundant braking system is created. In known applications, a separate and independently configured emergency braking system was always used. The design of the electric motor according to the invention means that a separate emergency braking system can be dispensed with, while the redundancy of the electric motor ensures sufficient reliability.

It may also be provided that a plurality of the electric motors are installed in one vehicle. The individual electric motors may be configured redundantly to each other. This may be the case, for example, if the electric motors are configured as wheel hub motors.

Furthermore, it may be provided that the first row of coils and the second row of coils are arranged on the stator spaced from one another in the axial direction, wherein a central rotor disc of the rotor is arranged between the first row of coils and the second row of coils as viewed in the axial direction, wherein the rotor is configured as an internal rotor, wherein central rotor disc magnets are arranged on the rotor disc in a first regular pattern distributed about the rotational axis, wherein the rotor disc magnets are configured to interact with the first coils of the first row of coils and the second coils of the second row of coils, wherein the rotor disc magnets in a first arrangement each have a south pole facing the first row of coils and a north pole facing the second row of coils, and wherein the rotor disc magnets in a second arrangement each have a north pole facing the first row of coils and a south pole facing the second row of coils, in particular that the first arrangement of the rotor disc magnets and the second arrangement of the rotor disc magnets alternate. Such a configuration provides a particularly simple structure and is therefore easy to manufacture and also very robust.

In particular, it may be provided that the rotor disc magnets have a cylindrical configuration. Furthermore, it may be provided that a centre axis of the cylindrical rotor disc magnets is parallel to the rotational axis.

Of course, the rotor disc magnets may also have a different shape, such as a rectangular cross-section.

According to a particular embodiment, it is conceivable the first row of coils and the second row of coils are arranged on the stator spaced from one another in the axial direction, wherein the rotor is configured as an external rotor and wherein the rotor has a first end wall and a second end wall, wherein the first row of coils is associated with the first end wall and the second row of coils is associated with the second end wall. An electric motor configured in this way has a high power density.

According to an advantageous advancement, it may be provided that the rotor has first air gaps arranged in a first regular pattern distributed about the rotational axis in the first end wall and is configured as a reluctance rotor. An electric motor configured in this way has a simple structure and is therefore less prone to faults and also inexpensive to manufacture.

In particular, it may be advantageous if first end wall magnets are arranged on the first end wall in a first regular pattern distributed about the rotational axis, the first end wall magnets being configured to interact with the first coils of the first row of coils, wherein the first end wall magnets in a first end wall magnet arrangement each have a south pole facing the first row of coils and a north pole facing away from the first row of coils and wherein the first end wall magnets in a second end wall magnet arrangement each have a north pole facing the first row of coils and a south pole facing away from the first row of coils, in particular that the first arrangement of the first end wall magnets and the second arrangement of the first end wall magnets alternate. This measure has the advantage that the performance of the electric motor can further be increased.

Furthermore, it may be provided that second end wall magnets are arranged on the second end wall in a second regular pattern distributed about the rotational axis, the second end wall magnets being configured to interact with the second coils of the second row of coils, wherein the second end wall magnets in a second end wall magnet arrangement each have a south pole facing the second row of coils and a north pole facing away from the second row of coils, and wherein the second end wall magnets in a second end wall magnet arrangement each have a north pole facing the second row of coils and a south pole facing away from the second row of coils, in particular in that the first arrangement of the second end wall magnets and the second arrangement of the second end wall magnets alternate. This measure has the advantage that the performance of the electric motor can further be increased.

In particular, it may be provided that the end wall magnets have a cylindrical configuration. Furthermore, it may be provided that a centre axis of the cylindrical rotor disc magnets is parallel to the rotational axis.

Additionally or alternatively, it may be provided that first encased magnets are arranged on a casing which is radially external to the first coils in a first regular pattern distributed about the rotational axis, the first encased magnets being configured to interact with the first coils of the first row of coils, wherein the first encased magnets in a first encased magnet arrangement each have a south pole facing the first row of coils and a north pole facing away from the first row of coils, and wherein the first encased magnets in a second encased magnet arrangement each have a north pole facing the first row of coils and a south pole facing away from the first row of coils, in particular in that the first arrangement of the first encased magnets and the second arrangement of the first encased magnets alternate. This measure has the advantage that the performance of the electric motor can further be increased.

Furthermore, it may be provided that second encased magnets are arranged on a casing which is radially external to the second coils in a second regular pattern distributed about the rotational axis, the second encased magnets being configured to interact with the second coils of the second row of coils, wherein the second encased magnets in a first encased magnet arrangement each have a south pole facing the second row of coils and a north pole facing away from the second row of coils, and wherein the second encased magnets in a second encased magnet arrangement each have a north pole facing the second row of coils and a south pole facing away from the second row of coils, in particular in that the first arrangement of the second encased magnets and the second arrangement of the second encased magnets alternate. This measure has the advantage that the performance of the electric motor can further be increased.

Furthermore, it may be provided that the first end wall of the rotor has a shape element, wherein a motor connection component is coupled to the shape element of the rotor, in particular in that the shape element is configured in the form of one or more pins projecting axially from the first end wall. This measure has the advantage that the complete number of components can be reduced. In particular, it may be provided that the pins projecting axially from the first end wall have a thread and can therefore be used to hold a rim. In particular, a centring shoulder may be arranged in a central area of the rotor. The centring shoulder may be used to centre the rim.

In particular, it may be provided that a motor configured is used as a wheel hub motor.

A component to which the motor is coupled or which is driven by the motor, such as the wheel rim, may be described as a motor connection component.

In addition, it may be provided that the first iron cores are inserted into the first coils in such a way that an open end of the first leg facing away from the first base and an open end of the second leg of the first iron cores facing away from the first base face towards the first end wall. This measure can further increase the performance of the electric motor.

Another advantageous embodiment is one in which a motor housing is provided, wherein a temperature sensor is arranged in this motor housing. This measure can improve the monitorability and thus the durability of the electric motor.

According to an advancement, it is conceivable that a position encoder is arranged on the rotor. In particular, it may be provided that a sensor is configured that interacts with the position encoder. This measure allows the speed and position of the rotor to be monitored with a high degree of accuracy.

In particular, the position sensor may be configured in the form of a disc with edges arranged around the circumference. Furthermore, it may be provided that a position sensor is configured that is used to detect the position of the position encoder. In particular, it may be provided that the position sensor is configured as a Hall sensor that detects each of the edges.

In an alternative embodiment variant, it is also conceivable that the permanent magnets of the motor are used as a position encoder for the position sensor, in particular the Hall sensor.

It may also be useful if the first row of coils and the second row of coils are arranged spaced from each other on the stator in the radial direction. In particular, an electric motor configured in this way can have a short design in the axial direction and can therefore be installed in various applications where space is limited. In particular, it may be provided that the first coils are arranged at a first diameter and that the second coils are arranged at a second diameter.

In addition, it may be provided that a braking surface is provided directly on the rotor, wherein a brake pad is arranged on the stator which serves for frictional interaction with the braking surface. This has the advantage that the electric motor can also be used as a mechanical brake. This can further increase operational safety. For example, when using the electric motor as a wheel hub motor, this measure can achieve sufficient operational safety.

Furthermore, it may be provided that the rotor comprises a first rotor disc and a second rotor disc, wherein the first rotor disc and the second rotor disc are arranged at a distance from each other, wherein the first row of coils is associated with the first rotor disc and wherein the second row of coils is associated with the second rotor disc, wherein a first link motion is provided in the first rotor disc and a second link motion is provided in the second rotor disc, wherein a guide pin is provided, which is guided in the first link motion and in the second link motion, wherein the guide pin is coupled to a connecting piece which extends radially outwards between the first rotor disc and the second rotor disc. This opens up additional application possibilities for the electric motor.

A vehicle is configured according to the invention. The vehicle comprises an electric motor configured according to any of the above embodiments. In particular, the electric motor may be configured as a wheel hub motor.

The use of the electric motor according to the invention as a vehicle motor, in particular as a wheel hub motor, has the advantage that vehicle safety can be surprisingly improved by this measure. This can be attributed to the redundancy of the electric motor and the wide range of possible applications.

According to the invention, a method for operating said electric motor is provided. Here, the second coils of the second row of coils are energised in different operating modes independently of the first coils of the first row of coils.

The method according to the invention has the advantage that a large number of operating modes is possible and the electric motor can therefore be used in a variety of ways.

According to a particular embodiment, it is conceivable, that in a normal operating mode, the first coils of the first row of coils and the second coils of the second row of coils are energised in such a way that the first coils of the first row of coils and the second coils of the second row of coils are used to apply a drive torque to the rotor;
that in a recuperation mode, the first coils of the first row of coils and the second coils of the second row of coils are energised in such a way that the first coils of the first row coils and the second coils of the second row of coils are used to apply a braking torque to the rotor, wherein the energy generated in the process is fed into the power grid or temporarily stored in an accumulator;
that in a hybrid mode, the first coils of the first row coils and the second coils of the second row of coils are energised in such a way that the first coils of the first row of coils are used to apply a braking torque to the rotor and at the same time the second coils of the second row of coils are used to apply a driving torque to the rotor, wherein the energy generated in the first row of coils is used in the second row of coils.

Operating the electric motor in the aforementioned operating modes is advantageous in a variety of applications. The aforementioned operating modes are particularly advantageous when the electric motor is used in a vehicle, especially as a wheel hub motor.

For a better understanding of the invention, it is explained in more detail with the aid of the following figures.

The figures show a simplified, schematic representation as follows:

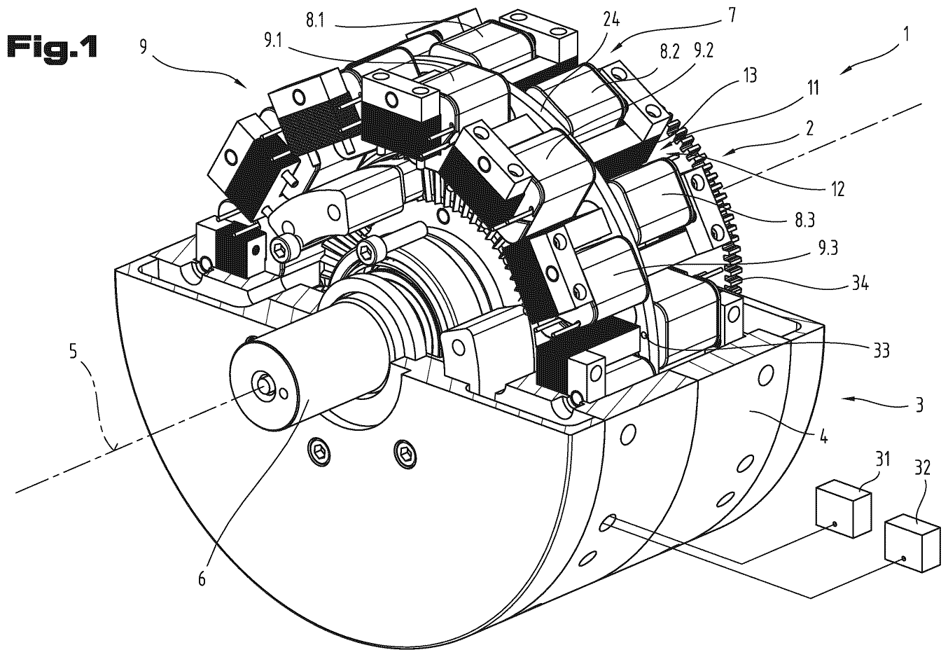

FIG. 1 a first exemplary embodiment of an electric motor with a motor housing in half section;

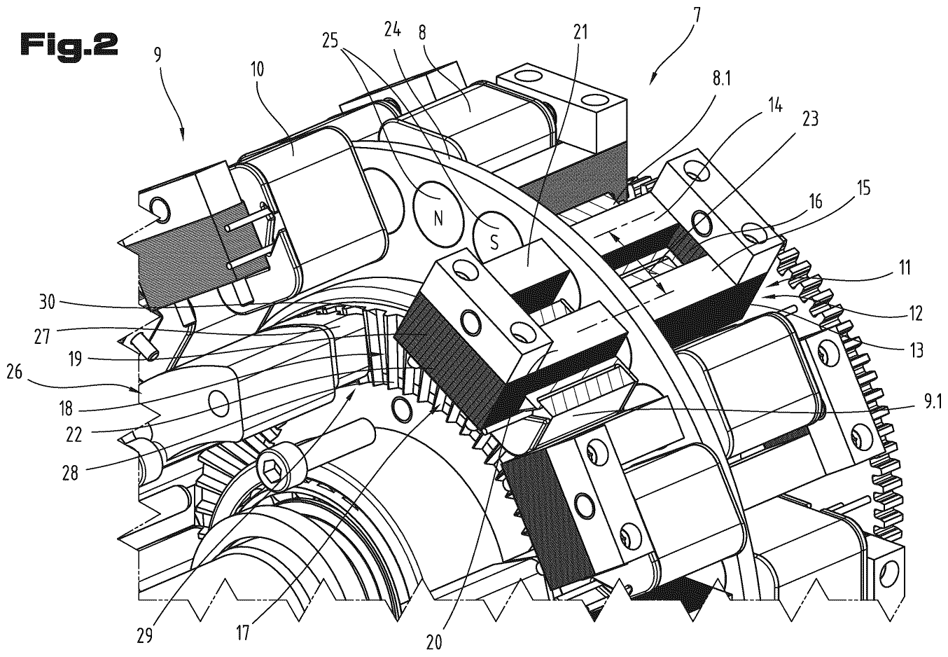

FIG. 2 a detailed view of the first exemplary embodiment of the electric motor;

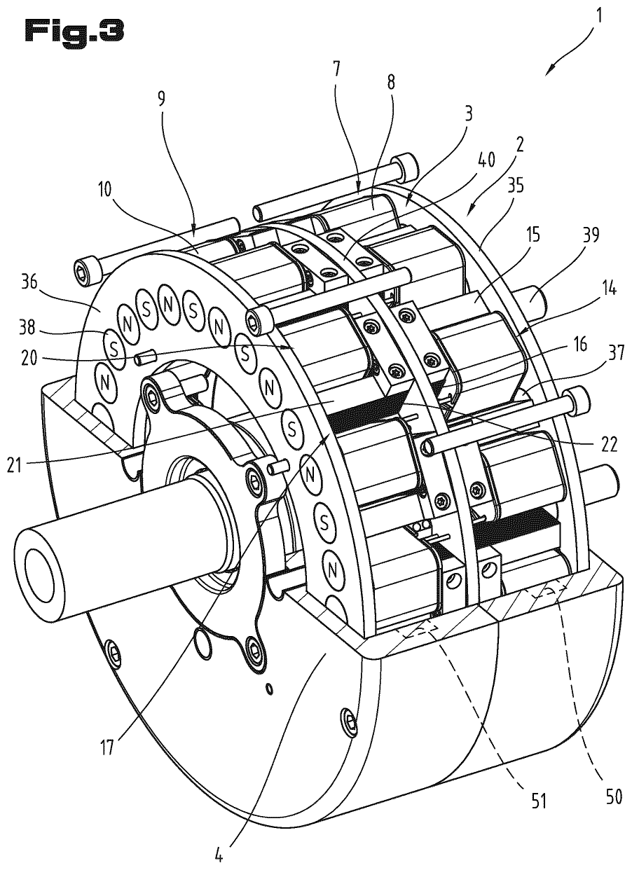

FIG. 3 a second exemplary embodiment of the electric motor with the motor housing in half section;

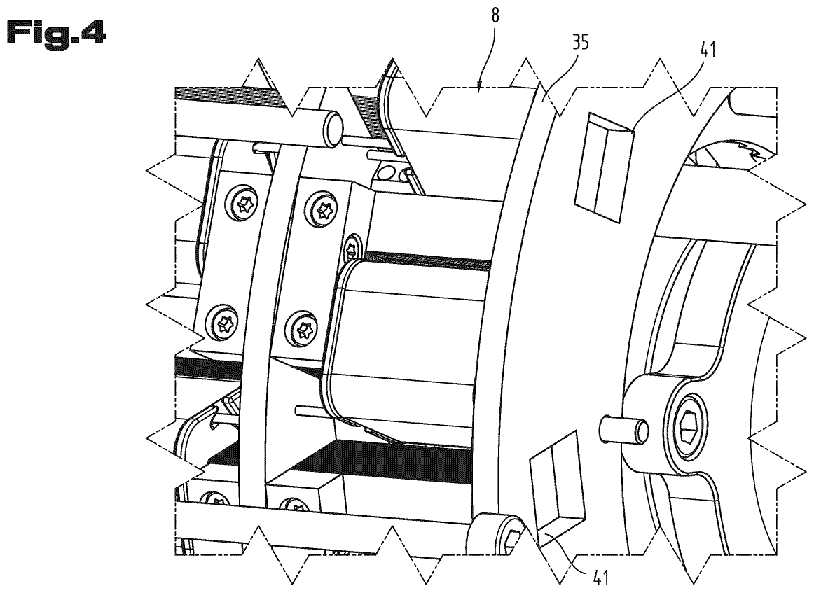

FIG. 4 a third exemplary embodiment of the electric motor with air gaps instead of magnets;

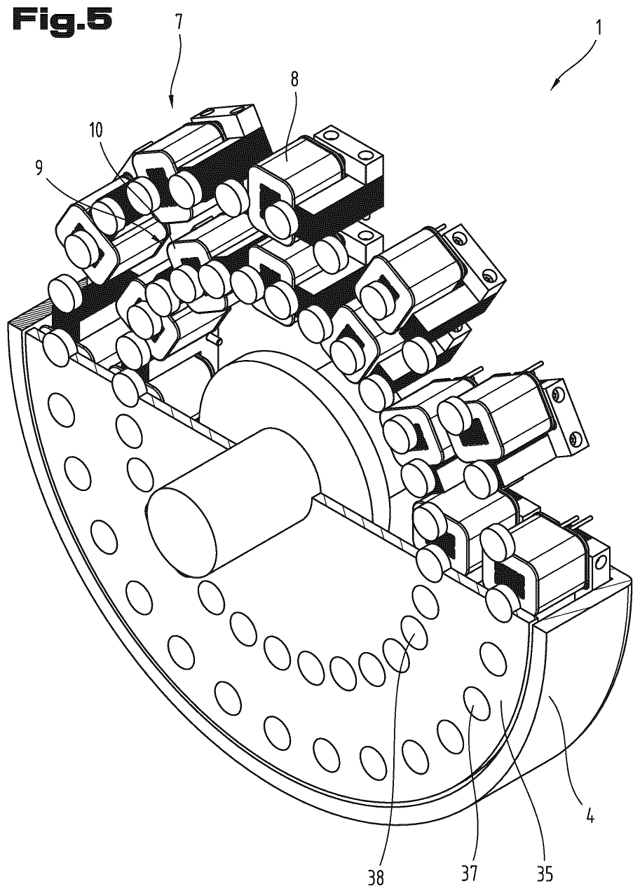

FIG. 5 a fourth exemplary embodiment of the electric motor with a radially inner and a radially outer row of coils;

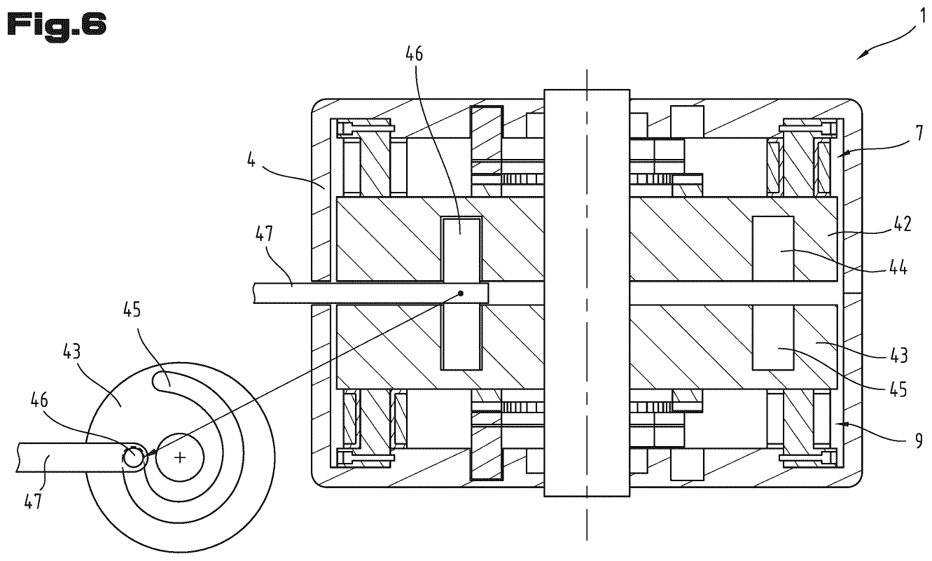

FIG. 6 a fifth exemplary embodiment of the electric motor with a link motion;

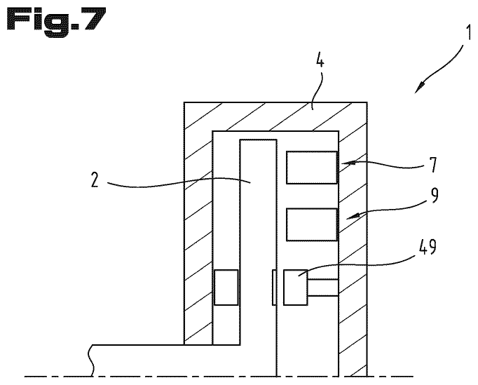

FIG. 7 a sixth exemplary embodiment of the electric motor with a mechanical friction lining brake.

By way of introduction, it should be noted that in the various embodiments described, the same parts are provided with the same reference signs or the same component designations, wherein the disclosures included in the entire description may be transferred analogously to the same parts with the same reference signs or the same component designations. The position details chosen in the description, such as top, bottom, side, etc., also refer to the directly described and illustrated figure and these position details are to be transferred to the new position accordingly in the event of a change of position.

FIG. 1 shows a first exemplary embodiment of an electric motor 1. The electric motor 1 comprises a rotor 2 and a stator 3. As may be seen in FIG. 1, it may be provided that the electro motor 1 is configured as an internal rotor. The stator 3 may comprise a motor housing 4. In particular, it may be provided that the motor housing 4 comprises several individual components. For the sake of clarity, FIG. 1 shows the motor housing 4 in a half section so that the internal components of the electric motor 1 are visible.

Furthermore, it may be provided that the rotor 2 can be rotated about a rotational axis 5 relative to the stator 3. Furthermore, it may be provided that a rotor shaft 6 is provided, which serves to couple components to be driven with the electric motor 1. As may further be seen in FIG. 1, it may be provided that a first row 7 of coils with a plurality of first coils 8 and a second row 9 of coils with a plurality of second coils 10 is coupled to the stator 3.

The individual first coils 8 of the first row 7 of coils may be arranged in a regular pattern distributed about the rotational axis 5. In particular, it may be provided that the individual first coils 8 each have the same configuration. The individual first coils 8 arranged around the circumference can also have an individual indexed designation, for example a first first coil 8.1, a second first coil 8.2, a third first coil 8.3, etc.

FIG. 2 shows a detail from FIG. 1, wherein in FIG. 2, the individual coils 8, 10 or the design of the coils 8, 10 is shown. For the sake of clarity, one of the second coils 10 is hidden in FIG. 2. Another of the second coils 10 and also one of the first coils 8 is shown in half section so that the components described below are visible.

As may be seen particularly well from FIG. 2, it may be provided that a first iron core 11 is provided. The first iron core 11 may comprise a first stack of plates 12 consisting of several individual first plates 13. The individual first plates 13 may be stacked congruently on top of each other.

In particular, it may be provided that the first iron core 11 has a first leg 14 and a second leg 15. The first leg 14 and the second leg 15 may be arranged parallel to each other. Furthermore, it may be provided that the first leg 14 and the second leg 15 are coupled to one another by means of a first base 16. In particular, it may be provided that the first leg 14, the second leg 15 and the base 16 have a U-shaped configuration. Furthermore, it may be provided that the first coil 8 surrounds the first leg 14.

Furthermore, it may be provided that a second iron core 17 is provided. The second iron core 17 may comprise a second stack of plates 18 consisting of several individual second plates 19. The individual second plates 19 may be stacked congruently on top of each other.

In particular, it may be provided that the second iron core 17 has a first leg 20 and a second leg 21. The first leg 20 and the second leg 21 may be arranged parallel to each other. Furthermore, it may be provided that the first leg 20 and the second leg 21 are coupled to one another by means of a second base 22. In particular, it may be provided that the first leg 20, the second leg 21 and the base 16 have a U-shaped configuration. Furthermore, it may be provided that the second coil 10 surrounds the first leg 20.

The first leg 14 and the second leg 15 of the first iron core 11 and the first leg 20 and the second leg 22 of the second iron core 17 may face each other at their open end.

In particular, it may be provided that the first coils 8 are screwed to the motor housing 4 by means of the first iron cores 17 and the second coils 10 are screwed to the motor housing by means of the second iron cores 17. The first iron cores 17 or the second iron cores 17 may be screwed directly to the motor housing 4.

In particular, it may be provided that the first leg 14 of the first iron core 11 and the second leg 21 of the second iron core 17 are arranged opposite each other or in extension of each other. Furthermore, it may be provided that the first leg 20 of the second iron core 17 and the second leg 15 of the first iron core 11 are arranged opposite each other or in alignment with each other. It may thus be provided that the first first coil 8.1 and the first second coil 10.1 are arranged at an offset angle 23 relative to one another. The offset angle 23 results from the distance between the first leg 14 and the second leg 15 of the first iron core 11.

As may be clearly seen from FIG. 2, it may be provided that the first coil 8 and the first iron core 11 and the second coil 10 and the second iron core 17 are of identical construction. In particular, it may be provided that the second coil 10 and the second iron core 17 are installed rotated by 180° relative to the first coil 8 and to the first iron core 11.

As may further be seen from FIGS. 1 and 2, it may be provided that a central rotor disc 24 is provided that can be rotated as part of the rotor 2 about the rotational axis 5.

Rotor disc magnets 25 may be arranged in the central rotor disc 24. The rotor disc magnets 25 may penetrate the central rotor disc 24 in axial direction. Furthermore, it may be provided that the rotor disc magnets 25 are arranged alternately in the central rotor disc 24 in such a way that the north pole of one of the rotor disc magnets 25 is associated with the first row 7 of coils and the south pole of this rotor disc magnet 25 is associated with the second row 9 of coils. The adjacent rotor disc magnet 25 may be configured in such a way, that the south pole of this adjacent rotor disc magnet 25 faces the first row 7 of coils and the north pole of this adjacent rotor disc magnet 25 faces the second row 9 of coils.

The first leg 14 and the second leg 15 of the first iron core 11 may face at its open ends facing away from the first base 16 to the central rotor disc 24. In particular, it may be provided that the first iron core 11 is used together with the central rotor disc 24 or together with the rotor disc magnets 25 arranged in the central rotor disc 24 to configure the magnetic field lines.

As may further be seen from FIG. 2, it may be provided that a parking brake 26 is provided in the electric motor 1. In this case, it may be provided that a brake element 27 is mounted on the stator 3 so that it can be displaced in the axial direction. Furthermore, it may be provided that a shaped recess 28 is provided on the rotor 2, wherein the brake element 27 can be brought into positive engagement with the shaped recess 28 by axial displacement. In the present exemplary embodiment, a toothing 29 is provided on the brake element 27. A mating toothing 30 is provided on the rotor 2 which can interact with the toothing 29. In particular, it may be provided that the mating toothing 30 is arranged on the central rotor disc 24.

Of course, the parking brake 26 may also be designed differently in a different configuration.

As schematically indicated in FIG. 1, it may be provided that a first circuit board 31 and a second circuit board 32 are provided. The first circuit board 31 may be used to control the first row 7 of coils and the second circuit board 32 may be used to control the second row 9 of coils. The first circuit board 31 and the second circuit board 32 may be used independently of each other to control the respective rows of coils, so that the electric motor 1 can have redundancy for safe operation. In particular, it may be provided that the first circuit board 31 and the second circuit board 32 are controlled by a common controller. In an alternative embodiment variant, it may be provided that a separate controller is provided each for controlling the first circuit board 31 and the second circuit board 32.

Furthermore, it may be provided that a temperature sensor 33 is arranged in the motor housing 4. The temperature sensor 33 can be used for determining the internal temperature in the motor housing 4.

As may further be seen from FIG. 1, it may be provided that a position encoder 34 is provided that, in combination with a corresponding sensor, can be used for determining the angular position of the rotor 2. In particular, it may be provided that the position encoder 34 is configured in the shape of a disc, which has individual edges with a toothed shape on its outer circumference. The sensor can be used to detect a rising edge and calculate the current angular position by dividing the edges.

FIG. 3 shows a further and possibly independent embodiment of the electric motor 1 again using the same reference signs or component designations for the same parts as in the preceding FIGS. 1 and 2. In order to avoid unnecessary repetition, reference is made to the detailed description in the preceding FIGS. 1 and 2.

The second exemplary embodiment of the electric motor 1 from FIG. 3 is shown in a view analogous to FIG. 1.

As may be seen from FIG. 3, it may be provided that the electric motor 1 is configured as an external rotor motor. In particular, it may be provided that the motor housing 4 of the external rotor motor is configured as a part of the rotor 2.

Furthermore, it may be provided that a first end wall 35 is provided and that a second end wall 36 is provided. The first end wall 35 may be associated with the first row 7 of coils and the second end wall 36 may be associated with the second row 9 of coils.

The first end wall 35 and the second end wall 36 may be coupled to the motor housing 4 in a torsionally rigid manner or the first end wall 35 and the second end wall 36 may be configured directly in the motor housing 4 and thus form a part of the rotor 2.

As may also be seen from FIG. 3, it may be provided that first end wall magnets 37 are arranged in the first end wall 35. It may further be provided that second end wall magnets 38 are arranged on the second end wall 36.

The first end wall magnets 37 may be arranged alternately in the first end wall 35 in such a way that the north pole of one of the first end wall magnets 37 is associated with the first row 7 of coils and the south pole of this first end wall magnet 37 faces outwards. The adjacent first end wall magnet 37 may be configured in such a way, that the south pole of this adjacent first end wall magnet 37 faces the first row 7 of coils and the north pole of this adjacent first end wall magnet 37 faces outwards.

In an analogue manner, the second end wall magnets 38 may be arranged alternately in the second end wall 36.

As further indicated in FIG. 3, first encased magnets 50 and second encased magnets 51 may be arranged in the motor housing 4 additionally or alternatively to the end wall magnets 37, 38.

The first encased magnets 50 may be arranged radially on the outside of the first row 7 of coils. The second encased magnets 51 may be arranged radially on the outside of the second row 10 of coils.

Furthermore, it may be provided that a shape element 39 is coupled to the first end wall 35 or the motor housing 4 which is used for driving or transferring the torque in a positive engagement to the motor connection component. In particular, it may be provided that the shape element 39 is configured in the form of pins projecting axially from the first end wall 35. If the electric motor 1 is configured as a wheel hub motor, for example, it may be provided that the shape elements 39 are configured as grub screws and serve directly to hold a rim.

As may further be seen from FIG. 3, it may be provided that the first row 7 and the second row 9 of coils are arranged axially between the first end wall 35 and the second end wall 36.

Furthermore, it may be provided that the first base 16 of the first iron core 11 and the second base 22 of the second iron core 17 face each other. Furthermore, the first leg 14 and the second leg 15 of the first iron core 11 may face the first end wall 35 and be open in the direction of the first end wall 35. Furthermore, the first leg 20 and the second leg 22 of the second iron core 17 may face the second end wall 36 and be open in the direction of the second end wall 36.

As may be seen from FIG. 3, it may be provided that the stator 3 comprises a carrier component 40 which is arranged between the first row 7 of coils and the second row 9 of coils and is used to hold the first row 7 of coils and the second row 9 of coils.

FIG. 4 shows a further and possibly independent embodiment of the electric motor 1 again using the same reference signs or component designations for the same parts as in the preceding FIGS. 1 to 3. In order to avoid unnecessary repetition, reference is made to the detailed description in the preceding FIGS. 1 to 3.

FIG. 4 shows an exemplary embodiment of a modification of the external rotor motor from FIG. 3, wherein this may have a structure similar in principle to the electric motor 1 from FIG. 3. As may be seen from FIG. 4, it may be provided that a plurality of first air gaps 41 is arranged in the first end wall 35 distributed over the circumference. These first air gaps 41 may be provided instead of the first end wall magnets 37. By said arrangement of first air gaps 41, a reluctance motor can be formed.

In an analogue manner to the first end wall 35, air gaps may also be arranged in the second end wall 36.

FIG. 5 shows a further and possibly independent embodiment of the electric motor 1 again using the same reference signs or component designations for the same parts as in the preceding FIGS. 1 to 4. In order to avoid unnecessary repetition, reference is made to the detailed description in the preceding FIGS. 1 to 4.

As may be seen from FIG. 5, it may be provided that in this further configuration the first row 7 of coils is arranged radially on the outside around the second row 9 of coils. The individual first coils 8 or the individual second coils 10 may be configured as in the previous exemplary embodiments. For the sake of simplicity, the structure of the coils 8, 10 refers to the embodiments already described.

In the exemplary embodiment according to FIG. 5, it may be provided that the first iron cores 11 and the second iron cores 17 have the same orientation. In particular, it may be provided, that in the first end wall 35 both first end wall magnets 37 for interacting with the first coil 8 and second end wall magnets 38 for interacting with the second coils 10 are arranged.

The electric motor 1 according to FIG. 5 may also be configured as an external rotor.

FIG. 6 shows a further and possibly independent embodiment of the electric motor 1 again using the same reference signs or component designations for the same parts as in the preceding FIGS. 1 to 5. In order to avoid unnecessary repetition, reference is made to the detailed description in the preceding FIGS. 1 to 5.

As may be seen from the exemplary embodiment of the electric motor 1 according to FIG. 6, it may be provided that the first rotor disc 42 and a second rotor disc 43 are provided. The first rotor disc 42 may be associated with the first row 7 of coils. The second rotor disc 43 may be associated with the second row 9 of coils. Furthermore, it may be provided that a first link motion 44 is provided in the first rotor disc 42. Furthermore, it may be provided that a second link motion 45 is provided in the second rotor disc 43.

Furthermore, it may be provided that a guide pin 46 is provided which engages in the first link motion 44 and the second link motion 45. Furthermore, it may be provided that a connecting piece 47 is provided that is coupled to the guide pin 46 and that extends through the motor housing 4 outwards. In particular, it may be provided that the first link motion 44 and the second link motion 45 have an eccentric link path. By rotating the first rotor disc 42 and the second rotor disc 43 by means of the first row 7 of coils and the second row 9 of coils, a radial displacement of the guide pin 46 can be achieved.

By coupling the connecting piece 47 to the guide pin 46, a radial displacement of the connecting piece 47 similar to a crankshaft can be achieved. In particular, it may be provided that the first link motion 44 and the second link motion 45 are arranged helically in the first rotor disc 42 or in the second rotor disc 43. This measure allows radial shifting of the guide pin 46 by rotating the rotor disc 42, 43.

FIG. 7 shows a further and possibly independent embodiment of the electric motor 1 in an exemplary sectional view again using the same reference signs or component designations for the same parts as in the preceding FIGS. 1 to 6. In order to avoid unnecessary repetition, reference is made to the detailed description in the preceding FIGS. 1 to 6.

As may be seen from FIG. 7, it may be provided that a braking surface 48 is provided on the rotor 2 that is used for interacting with a brake pad 49. In particular, it may be provided that the brake pad 49 is coupled to the motor housing 4 in an axially displaceable manner and configured to abutting at the braking surface 48.

The exemplary embodiments show possible embodiment variants, wherein it should be noted at this point that the invention is not limited to the specifically illustrated embodiment variants thereof, but rather various combinations of the individual embodiment variants with one another are also possible and this variation possibility lies within the ability of the skilled person working in this technical field due to the teaching on technical action by the present invention.

The scope of protection is determined by the claims. However, the description and the drawings should be consulted to interpret the claims. Individual features or combinations of features from the various exemplary embodiments shown and described may constitute inventive solutions in their own right. The object underlying the independent inventive solutions may be taken from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

List of reference signs

| | |
|---|---|
| 1 | electric motor |
| 2 | rotor |
| 3 | stator |
| 4 | motor housing |
| 5 | rotational axis |
| 6 | rotor shaft |
| 7 | first row of coils |
| 8 | first coil |
| 9 | second row of coils |
| 10 | second coil |
| 11 | first iron core |
| 12 | first stack of plates |
| 13 | first plate |
| 14 | first leg first iron core |
| 15 | second leg first iron core |
| 16 | first base first iron core |
| 17 | second iron core |
| 18 | second stack of plates |
| 19 | second plate |
| 20 | first leg second iron core |
| 21 | second leg second iron core |
| 22 | second base second iron core |
| 23 | offset angle |
| 24 | central rotor disc |
| 25 | rotor disc magnet |
| 26 | parking brake |
| 27 | brake element |
| 28 | shaped recess |
| 29 | toothing |
| 30 | mating toothing |
| 31 | first circuit board |
| 32 | second circuit board |
| 33 | temperature sensor |
| 34 | position encoder |
| 35 | first end wall |
| 36 | second end wall |
| 37 | first end wall magnet |
| 38 | second end wall magnet |
| 39 | shape element |
| 40 | carrier component |
| 41 | first air gap |
| 42 | first rotor disc |
| 43 | second rotor disc |
| 44 | first link motion |
| 45 | second link motion |
| 46 | guide pin |
| 47 | connecting piece |
| 48 | braking surface |
| 49 | brake pad |
| 50 | first encased magnet |
| 51 | second encased magnet |

1: An electric motor (1), comprising:
a rotor (2);
a stator (3), said rotor (2) being rotatable relative to the stator (3) about a rotational axis (5),
wherein
a first row (7) of coils is provided with a plurality of first coils (8), the first coils (8) being arranged on the rotor (2) or on the stator (3) in a first regular pattern distributed about the rotational axis (5), and wherein
a second row (9) of coils is provided with a plurality of second coils (10), the second coils (10) being arranged on the rotor (2) or on the stator (3) in a second regular pattern distributed about the rotational axis (5),
wherein the first row (7) of coils and the second row (9) of coils are spatially separated on the same component selected from rotor (2) or the stator (3),
wherein the second coils (10) of the second row (9) of coils can be energized independently of the first coils (8) of the first row (7) of coils.

2: The electric motor (1) according to claim 1, wherein all of the first coils (8) of the first row (7) of coils are arranged offset at an offset angle (23) about the rotational axis (5) with respect to the respectively nearest second coil (10) of the second row (9) of coils.

3: The electric motor (1) according to claim 1, wherein first iron cores (11) are inserted into the first coils (8), in particular wherein the first iron cores (11) each have a first stack of plates (12) with a plurality of first plates (13) arranged one above the other, wherein the first iron cores (11) are configured in a U-shaped manner with a first leg (14) and a second leg (15) and a first base (16) connecting the two legs (14, 15), and wherein the first leg (14) of the first iron cores (11) is arranged respectively within one of the first coils (8), and wherein second iron cores (17) are inserted into the second coils (10), in particular wherein the second iron cores (17) each have a second stack of plates (18) with a plurality of second plates (19) arranged one above the other, wherein the second iron cores (17) are configured in a U-shaped manner with a first leg (20) and a second leg (21) and a second base (22) connecting the two legs (20, 21), and wherein the first leg (20) of the second iron cores (17) is arranged respectively within the second coils (10).

4: The electric motor (1) according to claim 2, wherein the offset angle (23) is selected in such a way that the second leg (21) of the second iron core (17) is arranged as an extension of the first leg (14) of the first iron core (11) and wherein the first leg (20) of the second iron core (17) is arranged as an extension of the second leg (15) of the first iron core (11).

5: The electric motor (1) according to claim 1, wherein the individual first coils (8) of the first row (7) of coils can be energized completely independently of one another, or
wherein the individual first coils (8) of the first row (7) of coils are combined in energization groups, wherein the first coils (8) of an energization group can be energized together and the different energization groups can be energized independently of one another.

6: The electric motor (1) according to claim 1, wherein a parking brake (26) is provided, wherein a brake element (27) is displaceably arranged on the stator (3), in particular displaceable in the axial direction, wherein the brake element (27) is configured for positive engagement with a shaped recess (28) on the rotor (2).

7: The electric motor (1) according to claim 6, wherein a toothing (29) is configured on the brake element (27) and wherein a mating toothing (30) is configured on the rotor (2), wherein the toothing (29) can be brought into positive engagement with the mating toothing (30).

8: The electric motor (1) according to claim 1, wherein the first coils (8) of the first row (7) of coils are controlled by a first circuit board (31) and the second coils (10) of the second row (9) of coils are controlled by a second circuit board (32), wherein the first row (7) of coils and the second row (9) of coils are configured for a redundant operation.

9: The electric motor (1) according to claim 1, wherein the first row (7) of coils and the second row (9) of coils are arranged on the stator (3) spaced from one another in the axial direction, wherein a central rotor disc (24) of the rotor (2) is arranged between the first row (7) of coils and the second row (9) of coils as viewed in the axial direction, wherein the rotor (2) is configured as an internal rotor, wherein central rotor disc magnets (25) are arranged on the rotor disc (24) in a first regular pattern distributed about the rotational axis (5), wherein the rotor disc magnets (25) are configured to interact with the first coils (8) of the first row (7) of coils and the second coils (10) of the second row (9) of coils, wherein the rotor disc magnets (25) in a first arrangement each have a south pole facing the first row (7) of coils and a north pole facing the second row (9) of coils, and wherein the rotor disc magnets (25) in a second arrangement each have a north pole facing the first row (7) of coils and a south pole facing the second row (9) of coils, in particular wherein the first arrangement of the rotor disc magnets (25) and the second arrangement of the rotor disc magnets (25) alternate.

10: The electric motor (1) according to claim 1, wherein the first row (7) of coils and the second row (9) of coils are arranged on the stator (3) spaced from one another in the axial direction, wherein the rotor (2) is configured as an external rotor and wherein the rotor (2) has a first end wall (35) and a second end wall (36), wherein the first row (7) of coils is associated with the first end wall (35) and the second row of coils (9) is associated with the second end wall (36).

11: The electric motor (1) according to claim 10, wherein the rotor (2) has first air gaps (41) arranged in a first regular pattern distributed about the rotational axis (5) in the first end wall (35) and is configured as a reluctance rotor.

12: The electric motor (1) according to claim 10, wherein first end wall magnets (37) are arranged on the first end wall (35) in a first regular pattern distributed about the rotational axis (5), the first end wall magnets (37) being configured to interact with the first coils (8) of the first row (7) of coils, wherein the first end wall magnets (37) in a first end wall magnet arrangement each have a south pole facing the first row (7) of coils and a north pole facing away from the first row (7) of coils and wherein the first end wall magnets (37) in a second end wall magnet arrangement each have a north pole facing the first row (7) of coils and a south pole facing away from the first row (7) of coils, in particular wherein the first arrangement of the first end wall magnets (37) and the second arrangement of the first end wall magnets (37) alternate.

13: The electric motor (1) according to claim 10, wherein the first end wall (35) of the rotor (2) has a shape element (39), wherein a motor connection component is coupled to the shape element (39) of the rotor (2), in particular wherein the shape element (39) is configured in the form of one or more pins projecting axially from the first end wall (35).

14: The electric motor (1) according to claim 3, wherein the first iron cores (11) are inserted in the first coils (8) in such a way that an open end of the first leg (14) facing away from the first base (16) and of the second leg (15) of the first iron cores (11) faces in the direction of the first end wall (35).

15: The electric motor (1) according to claim 1, wherein a motor housing (4) is provided, wherein a temperature sensor (33) is arranged in this motor housing (4).

16: The electric motor (1) according to claim 1, wherein a position encoder (34) is arranged on the rotor (2).

17: The electric motor (1) according to claim 1, wherein the first row (7) of coils and the second row (9) of coils are arranged spaced to each other in the radial direction on the stator (3).

18: The electric motor (1) according to claim 1, wherein a braking surface (48) is provided directly on the rotor (2), wherein a brake pad (49) is arranged on the stator (3) which serves for frictional interaction with the braking surface (48).

19: The electric motor (1) according to claim 1, wherein the rotor (2) comprises a first rotor disc (42) and a second rotor disc (43), wherein the first rotor disc (42) and the second rotor disc (43) are arranged at a distance from each other, wherein the first row (7) of coils is associated with the first rotor disc (42) and wherein the second row (9) of coils is associated with the second rotor disc (43), wherein a first link motion (44) is provided in the first rotor disc (42) and a second link motion (45) is provided in the second rotor disc (43), wherein a guide pin (46) is provided, which is guided in the first link motion (44) and in the second link motion (45), wherein the guide pin (46) is coupled to a connecting piece (47) which extends radially outwards between the first rotor disc (42) and the second rotor disc (43).

20: A vehicle with an electric motor, wherein
the electric motor is configured according to claim 1, in particular wherein the electric motor is used as a wheel hub motor.

21: A method for operating an electric motor (1) according to claim 1, wherein
the second coils (10) of the second row (9) of coils are energized in different operating modes independently of the first coils (8) of the first row (7) of coils.

22: The method according to claim 21, wherein, in a normal operating mode, the first coils (8) of the first row (7) of coils and the second coils (10) of the second row (9) of coils are energized in such a way that the first coils (8) of the first row (7) of coils and the second coils (10) of the second row (9) of coils are used to apply a drive torque to the rotor (2);
wherein in a recuperation mode, the first coils (8) of the first row (7) of coils and the second coils (10) of the second row (9) of coils are energized in such a way that the first coils (8) of the first row (7) coils and the second coils (10) of the second row (9) of coils are used to apply a braking torque to the rotor (2), wherein the energy generated in the process is fed into the power grid or temporarily stored in an accumulator;
wherein in a hybrid mode, the first coils (8) of the first row (7) coils and the second coils (10) of the second row (9) of coils are energized in such a way that the first coils (8) of the first row (7) of coils are used to apply a braking torque to the rotor (2) and at the same time the second coils (10) of the second row (9) of coils are used to apply a driving torque to the rotor (2), wherein the energy generated in the first row (7) of coils is used in the second row (9) of coils.
